(19) United States
(12) Patent Application Publication
(10) Pub. No.: US 2026/0029525 A1
(43) Pub. Date: Jan. 29, 2026

(54) HOLE MEASUREMENT SYSTEM

(71) Applicant: MTI GROUP PTY LTD, Wangara, Western Australia (AU)

(72) Inventors: James Matthew Richard FITZSIMONS, Wangara (AU); Nicholas Grant BODLEY, Wangara (AU); Jamie Ryan SMITH, Wangara (AU); Nathan James CLARK, Wangara (AU)

(21) Appl. No.: 18/997,007

(22) PCT Filed: Jul. 31, 2023
(86) PCT No.: PCT/AU2023/050714

§ 371 Date: Jan. 18, 2025

(30) Foreign Application Priority Data
Aug. 2, 2022 (AU) 2022902173

(51) Int. Cl. G01S 13/88; E21B 47/04; E21B 47/085; E21B 47/09; G01B 15/04; G01S 7/41

(52) U.S. Cl. CPC G01S 13/885; E21B 47/04; E21B 47/085; E21B 47/09; G01B 15/04; G01S 7/412; G01S 7/414

(57) ABSTRACT

A hole measurement system comprising: a sensor configured to take measurements when directed down the hole to provide measurement data, a processor for analysing the data and providing feedback to an operator, wherein the feedback indicates whether the measurement data represents a bottom of the hole, or an anomaly.

### FIELD OF THE INVENTION

The present invention relates to a hole measurement system for detecting characteristics, such as the depth, of a drilled blast hole.

### BACKGROUND

A known method of drilling and blasting a volume of earth to extract mineral bearing material is to generate a blast pattern which describes a number of holes to be drilled, such as in pit. A drill rig drills these holes. A quality control step takes place to measure the drilled holes to ensure they are as designed and redrilled as required. Following this, the holes are loaded with explosives and stemming ready to blast. A blast pattern may comprise many hundreds of holes. Many factors may cause the hole to not match the design requirement in the blast pattern. These factors may include water in the hole, cave-ins due to ground conditions, drill rig inaccuracy, voids present in the ground and other reasons. Drilled patterns may be left on shot for many days between drilling and loading, which allows weather to cause issues in the holes. The design requirements dictate both the detonation and resultant fragmentation of the volume of ground, and the floor profile of exposed ground once the blasted material has been removed. The floor profile is typically designed to be relatively flat and even, to enable vehicles to remove the blasted material and perform any subsequent stages of drill and blast.

As such, quality control is a necessary step before blasting to minimise explosives use and ensure the blast matches the design requirements.

A typical quality control process requires a tool being fed down each hole by an operator, to measure the depth and potentially other factors such as water presence or level within the hole.

One example of such a process involves a weighted tape measure being fed until the bottom of the hole is reached, then being withdrawn after the depth is recorded.

Another example is described in WO 2020/243797 in the name of the present applicant.

Such processes suffer from the drawback of the time taken to carry out the operation, by feeding the cable and sensor into the hole, taking and interpreting the reading, and withdrawing the cable before commencing the next hole.

The large number of holes commonly required to be subject to the quality control process means that any time saving that can be applied to each or at least some of the holes is beneficial.

Furthermore, in some cases the blast pattern can be inaccessible or dangerous to access, and a means to verify the condition of the holes remotely is advantageous.

The following discussion of the background art is intended to facilitate an understanding of the present invention only. It should be appreciated that the discussion is not an acknowledgement or admission that any of the material referred to was part of the common general knowledge as at the priority date of the application.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

### SUMMARY OF INVENTION

According to a first aspect of the present invention there is provided a hole measurement system comprising:
a sensor configured to take measurements when directed down the hole to provide measurement data,
a processor for analysing the data and providing feedback to an operator, wherein the feedback indicates whether the measurement data represents a bottom of the hole, or an anomaly.

According to a second aspect of the present invention there is provided a hole measurement system comprising:
a sensor configured to take measurements when directed down the hole to provide measurement data,
a processor for analysing the data and providing feedback to an operator, wherein the feedback includes depth of the hole.

According to a third aspect of the present invention there is provided a hole measurement system comprising:
a sensor configured to take a depth measurement of the hole to provide measurement data,
a processor for analysing the data and providing feedback to an operator, wherein the feedback includes differentiation between a bottom of hole depth measurement and an anomalous depth measurement.

According to a fourth aspect of the present invention there is provided a hole measurement system comprising:
a sensor configured to take measurements when directed down the hole to provide measurement data,
a processor for analysing the data and providing feedback to an operator, wherein the feedback indicates whether measurement data indicates a depth of a bottom of the hole or indicates that secondary measures are required.

According to a fifth aspect of the present invention there is provided a hole measurement system comprising:
a transmission means configured to direct a radio frequency signal down a hole,
a sensing means configured to receive radio frequency signals reflected from down the hole to provide measurement data,
a processing means for analysing the data and providing feedback to an operator, wherein the feedback includes one or both of: depth of the hole and identification of any anomalies.

According to a sixth aspect of the present invention there is provided a hole measurement system comprising:
a sensor configured to take measurements when directed down the hole to provide measurement data,
a processor for analysing the data and providing feedback to an operator, wherein the feedback includes altitude of toe of the hole.

In an embodiment, the feedback includes altitude of the toe of the hole with respect to a datum.

In an embodiment, the datum is sea level.
feedback includes altitude of the hole with respect to a defined datum.

In an embodiment, the datum is toes of other holes in the same blast pattern.

In an embodiment, the datum is a design altitude.

In an embodiment, the hole is a drilled blast hole.

In an embodiment, the hole comprises a substantially unobstructed surface opening.

In an embodiment, the hole is measured while absent of any drilling apparatus.

In an embodiment, the hole is less than 100 m deep.

In an embodiment, the hole is less than 1 m wide.

In an embodiment, the hole measurement system is configured to measure a plurality of holes in sequence.

In an embodiment, the hole measurement system is configured to measure a plurality of holes arranged in a pattern.

In an embodiment, the hole measurement system is configured to take down hole measurements of holes comprised within a blast pattern.

In an embodiment, the hole measurement system is configured to be mountable to a vehicle.

In an embodiment the vehicle is configured to traverse a blast pattern.

In an embodiment, the vehicle is a land vehicle, for example a car or truck.

In an embodiment, the vehicle is an aircraft, for example a helicopter or drone.

In an embodiment, the measurement system requires less than 18V input, preferably less than 12V.

In an embodiment, the measurement system weighs less than 1 kg, preferably less than 500 g.

In an embodiment, the sensor comprises a radio frequency transmitter and a receiver.

In an embodiment, the sensor comprises a radar sensor.

In an alternative embodiment, the sensor comprises an ultrasonic sensor.

In an alternative embodiment, the sensor comprises a lidar sensor.

In an embodiment, the sensor is contained in a housing, wherein the sensor is configured to be directed downwards when the housing is aimed down the hole.

In an embodiment, the housing comprises a focussing element.

In an embodiment, the sensor comprises a focussing element.

In an embodiment, the focussing element is an RF absorbing barrel.

In an embodiment, the focussing element is configured to narrow a field of view of the sensor.

In an embodiment, the sensor has a field of view of less than 90 degrees, preferably less than 70 degrees, for example 60 degrees.

In an embodiment, the focussing element is of a suitable length to narrow the field of view adequately, for example a length of between 100 mm and 400 mm, preferably 300 mm or less, more preferably between 120 mm and 150 mm.

In an embodiment, the processor is configured to receive a defined hole entrance height.

In an embodiment, the defined hole entrance height is able to be modified by a user.

In an embodiment, the system comprises a positioning device, such as a Global Navigation Satellite System (GNSS) receiver, and/or a Real Time Kinematic (RTK) receiver.

In an embodiment, the sensor is configured to measure distance within a field of view of the hole.

In an embodiment, the field of view of the hole measured includes at least a bottom of the hole.

In an embodiment, the field of view of the hole measured includes at least a portion of a side wall of the hole.

In an embodiment, the field of view of the hole measured includes a bottom and at least a portion of a side wall of the hole.

In an embodiment, the field of view further includes an entrance of the hole.

In an embodiment, the processor is further configured to receive external data, and to compare the external data with measurement data.

Preferably, the external data comprises the drilled depth provided by a drilling means such as a drilling rig.

In an embodiment, the processor is further configured to analyse an anomaly measurement and to determine the type of anomaly.

In an embodiment, the processor is further configured to analyse the measurement data and provide feedback, the feedback comprising all anomalies detected, including determined type and measured depth of each anomaly.

In an embodiment, an anomaly is determined by a difference between the measurement data and external data.

In an embodiment, an anomaly comprises water in the hole, defined herein as a wet hole.

In an embodiment, an anomaly comprises a protrusion from, or void in, a wall of the hole.

In an embodiment, the processor is configured to differentiate between an affirmative depth measurement and a measurement having an anomaly.

In an embodiment, the processor is configured to analyse the data to differentiate between different types of anomaly.

In an embodiment, the feedback includes the type of anomaly.

In an embodiment, the processor is configured to identify an anomaly based on a magnitude of a reading.

In an embodiment, the processor is configured to identify an anomaly when a signal to noise ratio (SNR) is above a threshold.

In an embodiment, the threshold is determined according to parameters of the hole.

In an embodiment, the threshold is a SNR of between 200 and 400.

In an embodiment, the threshold is a SNR of between 250 and 350.

In an embodiment, the processor is configured to alter parameters of the sensor based on the measurement data.

In an embodiment, the processor is configured to take further measurements following analysis of the measured data, wherein the further measurements are taken using different sensor parameters to parameters used to obtain the measurements, and wherein the different sensor parameters are defined by the analysis of the measurement data.

In an embodiment, the processor is configured to control the sensor based on the type of anomaly identified.

In an embodiment, the processor is configured to vary power output of the sensor following detection of a wet hole, and to adjust feedback provided once new measurement data is provided following the power variation.

According to a seventh aspect of the present invention there is provided a method of measuring a hole using a sensor configured to take measurements down the hole to provide measurement data, and a processor for analysing the data and providing feedback to an operator, wherein the feedback includes depth of the hole and/or identification of any anomalies, the method comprising the following steps:
a. Aiming the sensor down the hole,
b. using the sensor to transmit a signal and receive measurement data,
c. Using the processor, analysing measurement data to provide feedback to an operator, wherein the feedback indicates whether the measurement data represents a bottom of the hole, or an anomaly.

According to a eighth aspect of the present invention there is provided a method of measuring a hole using a sensor configured to take measurements down the hole to provide measurement data, and a processor for analysing the data and providing feedback to an operator, wherein the feedback includes depth of the hole and identification of any anomalies the method comprising the following steps:
a. aiming the sensor down the hole,
b. using the sensor to transmit a signal and receive measurement data,
c. using the processor, analysing measurement data,
d. in the event that an affirmative depth measurement is determined, providing feedback of the affirmative depth measurement, or in the event that anomalies are recorded, providing feedback that secondary measures are required.

According to an ninth aspect of the present invention there is provided a method of confirming a depth of a hole with respect to a target depth, the method comprising the following steps:
a. aiming a radio frequency transmitting means down the hole,
b. using a radio frequency receiving means to receive signals from down the hole to provide measurement data,
c. using a processing means to analyse the measurement data to determine whether the depth of the hole is in accordance with the target depth.

In an embodiment, the target depth is provided in the form of external data.

In an embodiment, the external data is the design depth of the hole.

In an embodiment, the external data is the drilled depth of the hole, wherein the data is provided by the drilling apparatus.

In an embodiment, at step c, the processing means compares the external data with the measurement data.

In an embodiment, also at step c, the comparison of external data and measurement data results in either an affirmative depth measurement or an anomaly, and wherein, in the event of an affirmative depth measurement, including the affirmative depth measurement in the feedback.

In an embodiment, if an anomaly is identified at step c., carrying out the following steps:
d. Using the processing means, analysing the anomaly identified to determine the type(s) of anomaly,
e. In the event of an anomaly being determined to be a protrusion or void in a wall of the hole, providing a depth of that anomaly and, in the event of an anomaly being determined to be water in the hole, identifying a wet hole to the operator.

In an embodiment, at step c., in the event of the analysis identifying an entrance, providing that entrance height to an operator.

In an embodiment, at step c., in the event of the analysis identifying a wet hole, varying the power of the sensor to provide new measurement data and, using the processor, analysing the new measurement data to verify the wet hole result and providing the verified wet hole result to an operator.

According to a tenth aspect of the present invention there is provided a hole measurement system comprising:
a sensor configured to take measurements when directed down the hole to provide measurement data,
a processor for analysing the data and providing feedback to an operator, wherein the feedback indicates one or both of: whether the measurement data represents a bottom of the hole and/or an anomaly.

### BRIEF DESCRIPTION OF DRAWINGS

In order to provide a better understanding, embodiments of the present invention will be described, by way of example only, with reference to the accompanying drawings, in which:

FIG. 1 is a view showing a measurement system according to an embodiment of the present invention.

FIG. 2 is a cross-section of a hole with a measurement system according to an embodiment of the present invention positioned at the entrance of the hole, shown in the process of taking a depth measurement.

FIG. 3 is a cross-section of a hole with a measurement system according to an embodiment of the present invention positioned at the entrance of the hole, shown in the process of taking a depth measurement, with water in the toe end of the hole (the bottom in the case of a vertical hole).

FIG. 4 is a cross-section of a hole with a measurement system according to an embodiment of the present invention positioned at the entrance of the hole, shown in the process of taking a depth measurement, with a void in one portion of the hole wall, and a protrusion in another portion of the hole wall.

FIG. 5 is a cross-section of a hole with a measurement system according to an embodiment of the present invention positioned above the entrance of the hole, shown in the process of taking a depth measurement, in which the entrance height is recorded in addition to the depth of the hole.

FIG. 6a is an example of a chart of measurement data that indicates a wet hole.

FIG. 6b is another example of a chart of measurement data that indicates a wet hole.

FIG. 6c is an example of a chart of measurement data that indicates a dry hole.

FIG. 6d is an example of a chart of measurement data that indicates a partially bridged hole.

FIG. 7 is a flow chart of a method according to an embodiment of the present invention.

FIG. 8 is a flow chart of a method according to an embodiment of the present invention.

### DESCRIPTION OF EMBODIMENTS

An aim of the invention is to save time spent verifying the condition of a blast pattern of holes using conventional means, which require dipping all of the holes with tools such as line-mounted sensors, to confirm that the depth is in accordance with the design intent, and that there is no water, obstructions or voids.

A blast pattern comprises many holes, and typically the majority of these holes are in accordance with design intent, and the invention aims to reduce the time spent by providing a rapid means to ascertain the condition without dipping the holes.

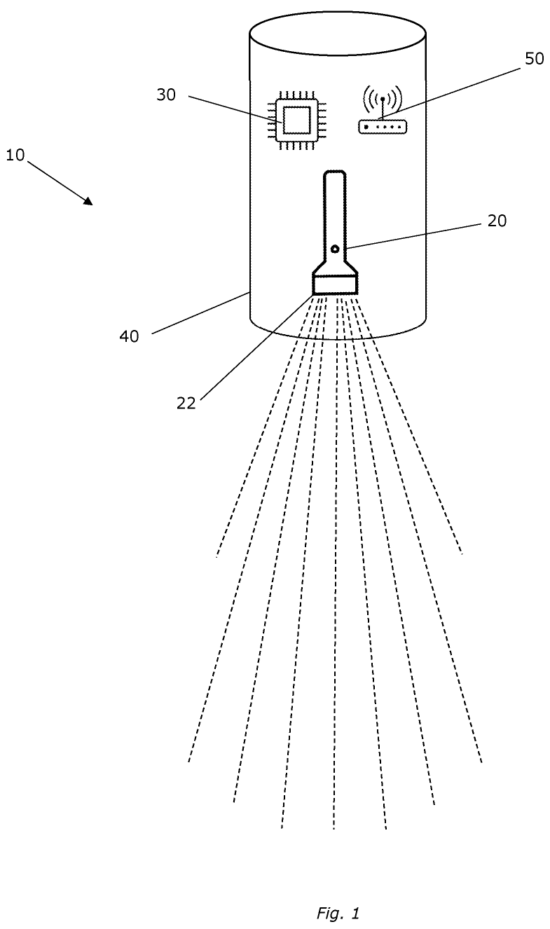

Referring to FIG. 1, there is shown a hole measurement system 10 according to a first aspect of the present invention, comprising a sensor 20 configured to take measurements down the hole to provide measurement data, and a processor 30 for analysing the data and providing feedback to an operator, wherein the feedback indicates whether the measurement data represents a bottom of the hole, and/or an anomaly.

The sensor 20 may comprise a radio frequency transmitter and receiver, may be a radar sensor, an ultrasonic sensor, a LIDAR sensor or any distance or depth capable sensor as would be understood to be suitable by a person skilled in the art.

The sensor 20 may comprise a combination of more than one type of sensor.

The preferred embodiment of the invention comprises radar as the sensor, although it is envisaged that other types may function to produce the results.

Radar is the preferred choice of sensor 20, in part due to the operating environment, as the hole may have airborne dirt and dust particles, and the field of use means that it is likely that mud and dirt may cover the surface of the housing 40 or sensor 20.

Radar is better able to penetrate such materials, whereas other types of sensor 20, for example LiDAR, may function poorly when obscured or when having to detect readings through dusty air.

The capability of radar to penetrate materials means that the sensor 20, where contained in a housing 40, can be protected by a portion of the housing 40 which may be formed into a radome. LiDAR on the other hand requires a screen to be unobscured, which may then become scratched or damaged thus affecting functionality and being expensive to repair or replace.

The cost of radar is also less than LiDAR.

A further benefit of radar is the lower resolution, radar returns a signal strength at a depth, whereas LiDAR returns a large number of discrete points which require analysis, therefore the computing power required to achieve results is less when using radar than when using LiDAR, another factor that contributes to lower cost.

The measurement system 10 may be mounted to a vehicle, or hand held. The vehicle may be a land vehicles such as a car or truck, or may be an aircraft such as a drone or helicopter.

The vehicle may be configured to traverse the blast pattern, to enable the measurement system 10 to take measurements from each hole in the blast pattern.

Examples of the holes to be measured may be drilled blast holes, and commonly such blast holes are less than 100 m deep and less than 1 m wide.

Such holes will typically have been drilled by a drilling rig, which has since been removed, and are unobstructed holes, save for any obstructions that may have occurred since drilling, such as collapse of a hole wall, or water collecting at the bottom.

The mass of the componentry required for a system 10 comprising radar is therefore lower than a comparative system comprising LiDAR, and the cost and mass contribute to the portability and mount ability of the system 10 to different vehicles. This is especially important when considering mounting to vehicles that have low carrying capacity, such as a drone.

Mass of componentry of the system may be affected by the mass of the sensor, but additionally by the power and computational requirements, both of which may require comparatively massive power sources, such as batteries.

In a lightweight application, such as a drone mounted measurement system 10, it may be required that the power source, computational capacity of the processor 30, mass of the sensor 20 are all minimised to the extent that a carrying capacity of the drone can be met, which may preclude the use of some components or types of components.

In such an application, the measurement system may be required to weigh less than 10 kg, preferably less than 2 kg, more preferably less than 500 g.

The system 10 may be arranged in many forms, suited to other types of mounting, for example land vehicles or a hand held apparatus.

To assist with automated traversing, the system 10 may further include a positioning means, for example a GNSS receiver, or an RTK receiver.

The sensor 20 may be contained in a housing 40 and arranged to be directed downwards when the housing 40 is aimed down a hole.

The sensor may have a field of view that is relatively narrow, advantageous in the application of down hole measurement, for example less than 90 degrees, preferably less than 70 degrees, for example 60 degrees.

The sensor 20, may have a field of view dictated by a focussing or screening element 22, such as an RF absorbing barrel. The focussing element 22 is beneficial in that it narrows the field of view of the sensor, focussing the signal to mask extraneous results and concentrates the field of view at the desired area.

The focussing element 22 may be of a suitable length to narrow the field of view adequately, for example between 100 mm and 400 mm, preferably 300 mm or less, more preferably between 120 mm and 150 mm.

The housing 40 generally may be formed of a material able to be penetrated by the sensor signals, for example at least the bottom surface may be able to be penetrated by the sensor signals.

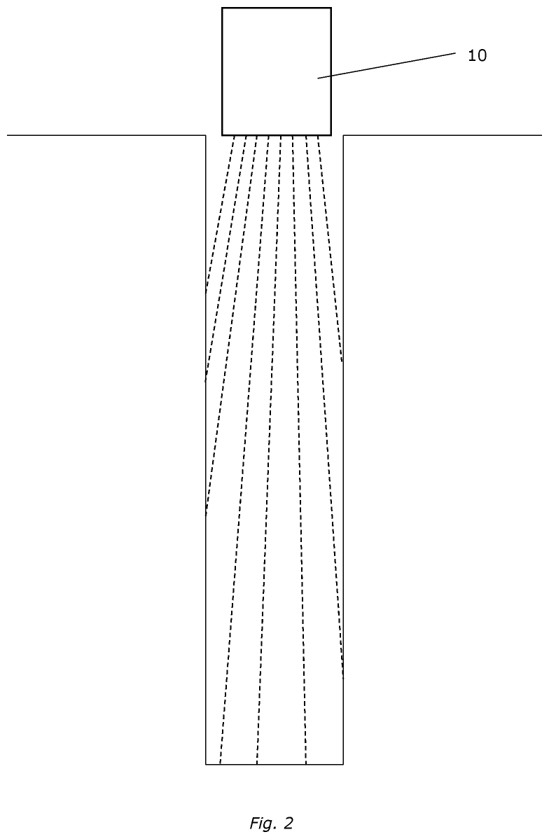

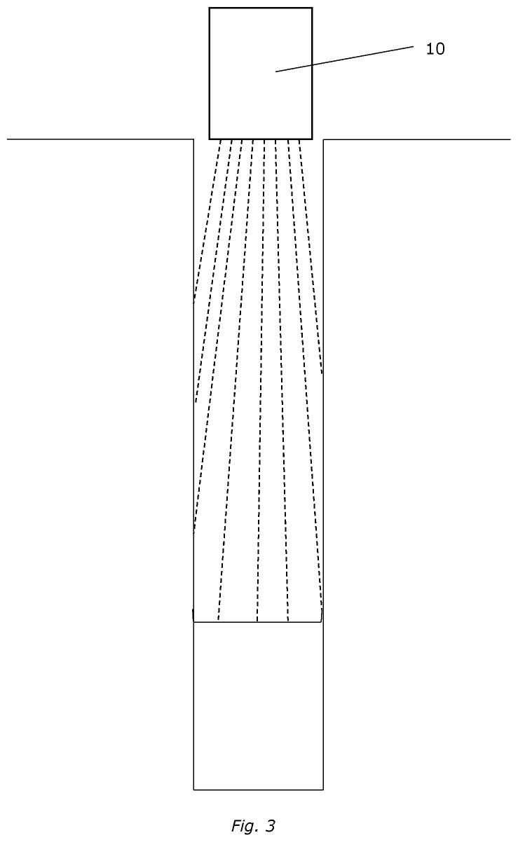

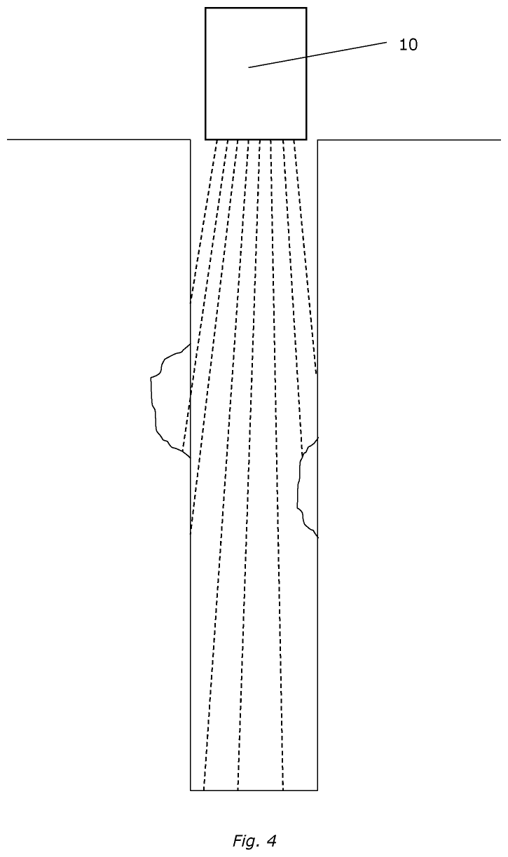

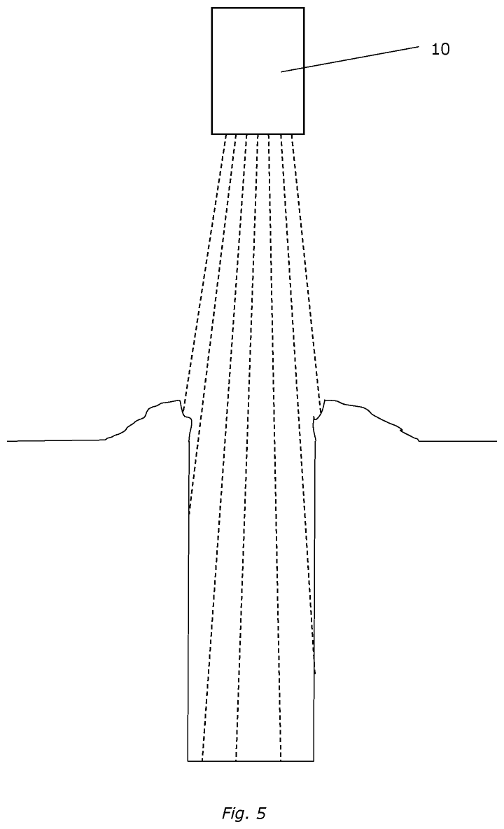

As shown in FIGS. 2 to 5, the beam or signal emitted from the sensor 20 may be directed at an area of the hole including at least a portion of the wall of the hole.

The sensor 20 may emit a signal at a selected frequency down the hole, and measurement data received may comprise a return signal at depths where reflection occurs. The intensity or strength of the return signal is an identification of the reflection at that depth, and/or of the reflective properties of the material reflecting the signal.

A strong return signal is an identification of a surface substantially normal to the direction of the beam, as the signal reflects back toward the sensor.

Commonly a bottom of a hole will result in a relatively strong return signal, as the geometry at the bottom of the hole may be broadly perpendicular to the direction of the hole or may constitute numerous surface portions perpendicular to the direction of the hole.

Alternatively, a concentration of weaker returns over a narrow depth range may be sufficient to indicate a bottom of hole reading.

An even stronger return signal may indicate a wet hole having a volume of water at the bottom. The stronger return signal may be received as a result of the higher reflectivity of the water, and may be further strengthened by the geometric nature of the reflective surface, being a flat surface causing the measurements to appear at the same depth, as opposed to a number of measurements over a depth range.

A weak return signal typically represents walls angled away from the sensor, rather than perpendicular, as the reflected signal is of lower strength than with a perpendicular surface.

A weak return can be an identification of a possible anomaly, for example a muddy hole, or a protrusion or a void in a wall of the hole.

A muddy hole may result in a weaker return than a dry hole.

The measurement must also have a known height for the hole entrance to be able to provide a depth. If the system 10 is held at the hole entrance, it may be presumed that the distance measured from the sensor is to be the distance from the hole entrance. However, it may be than the system 10 is not always held at the hole entrance.

The processor 30 may be configured to receive a defined hole entrance, the hole entrance may be defined in a number of ways, for example manually, or by measuring the ground level adjacent the hole entrance.

It may be that the hole entrance, also known as a collar, is not at the same level as the real level (RL) being the ground level before the hole was drilled. The different level of the hole entrance can be a result of material brought up from the hole during drilling being piled around the hole, causing the hole entrance to be higher that the surround ground level.

Alternatively, the hole entrance may be lower than the surrounding ground level, as the edge may collapse and media may fall into the hole.

A height at which an operator may hold the system 10 will affect a measurement, and thus defining the height of the hole entrance is advantageous.

Where the field of view includes the entrance of the hole, measured data may include a strong return at a shallow depth to identify and define the hole entrance, which can then be used to determine the depth measured at the bottom of the hole.

The system 10 may be moved, for example laterally or vertically, to bring the hole entrance, or ground further away from the hole entrance, into the field of view.

The system 10 may be positioned and aim such that the field of view includes the bottom of the hole, and may further include at least a portion of a wall of the hole, and may further include the hole entrance, and may further include a portion of ground around the hole entrance.

The defined hole entrance height may be able to be offset in a positive or negative direction, for example to account for a hole entrance that is considered to be higher or lower than the ground level before drilling.

The processor 30 may be configured to differentiate between an affirmative depth measurement and a measurement having an anomaly, for example data containing a return signal of expected intensity at a constant and/or expected depth and no additional returns could be indicative of an affirmative depth measurement.

The processor 30 may be further configured to receive external data, and to compare the external data with measurement data during analysis.

The external data may be the drilling data associated with each hole, and the processor 30 may compare the drilled depth with the measurement data to determine whether the depth measurement is an affirmative depth measurement.

The processor 30 may provide the feedback to the operator in the form of a simple to interpret signal, for example a green light, if the affirmative depth measurement is indicated.

For the purpose of clarification, an affirmative depth measurement is taken to mean a reading that provides sufficient confidence of being the bottom of the hole, that is where the return is of expected intensity and additional returns are either not present, or do not impact the confidence of the bottom of the hole reading to the extent that the confidence is insufficient to identify an affirmative depth measurement.

It is considered likely that the majority of drilled holes fall into this category, and the time taken to measure the hole is significantly less than with conventional methods, potentially taking less than 1 second once the measurement system 10 is aimed down the hole.

There is an advantage in the time saving resulting from this measurement system 10, especially given the multiplication factor due to the number of holes to which the time saving applies.

The measurement data can be interpreted in a number of ways to ascertain the characteristics of the hole.

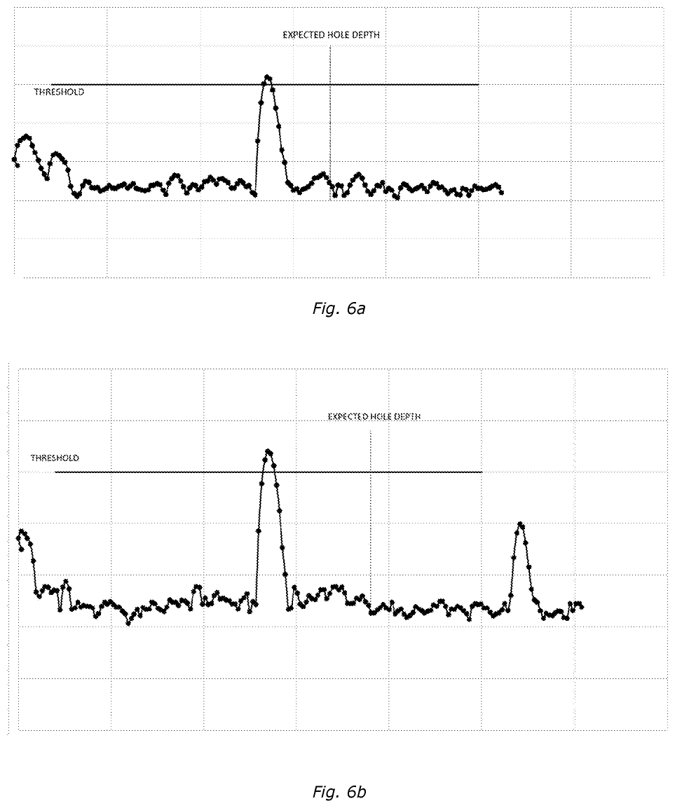

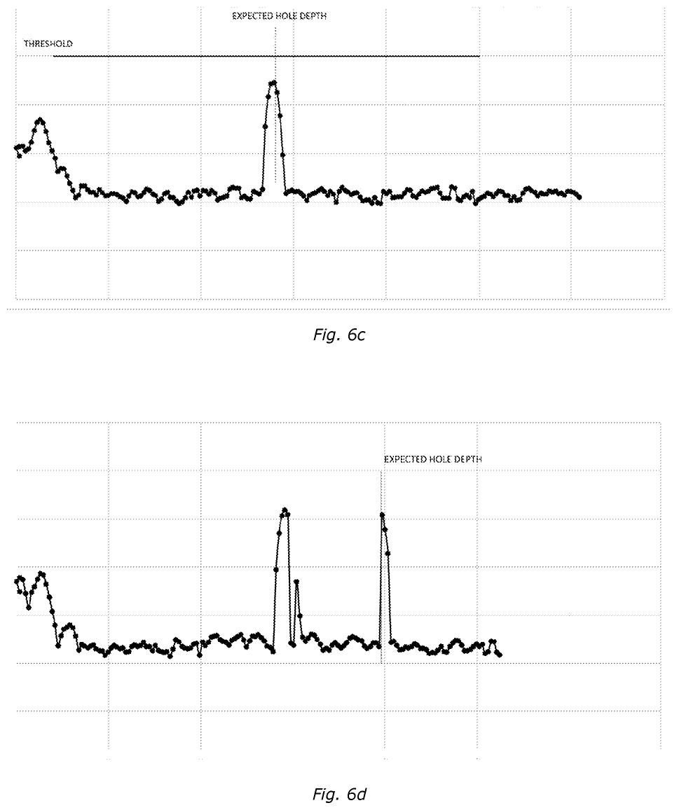

Referring to FIGS. 6a to 6d, examples of the types of return signals are provided that correlate to different types of anomaly.

Where measurement data contains anomalous data in addition to an otherwise affirmative depth measurement, it may be that the anomalous data can be interpreted in such a way that the confidence in the reading remains sufficiently high to provide an affirmative depth measurement.

FIG. 6a depicts a chart resulting from a wet hole, a return signal that is representative of water in the hole may be different to a bottom of the hole return signal.

Where water is present, the return signal may be stronger than the type of signal received in a dry hole, and may be recorded at a shallower depth than the drilled depth.

Where a volume of water is present the surface of the water will be flat, causing the return signal to be concentrated at a narrow depth range, for example less than 50 mm, or even less than 10 mm.

In addition, the radar attenuation properties of water are different to soil and/or rock, such that the return signal will have a greater SNR and is able to be differentiated from a dry hole.

The return signal is represented with respect to a threshold, where a reading above the threshold is indicative of a wet hole. In this example the threshold is set using a SNR of 300, it has been found that dry holes tend to have a SNR of between 100 and 200, and wet hoes tend to have an SNR of between 400 and 450.

In addition, referring to FIG. 6b, received data may include two returns at different depths, both FIG. 6b and FIG. 6d show return signals at two different depths, but the data provided if FIG. 6b is indicative of a wet hole, whereas FIG. 6d is indicative of a partial bridge, or protrusion into the hole.

Such returns may indicate a protrusion or void part way up the hole, in addition to, or instead of, a bottom of the hole.

FIG. 6b depicts a strong return, above the threshold, and a second weaker return. The second weaker return is depicted as being deeper than the expected hole depth, and double the distance from the sensor, than the first strong return.

Where water is present, the data typically presents a second return at a greater depth, the strength of the signal at the second return may be similar or slightly weaker than the first return.

The processor 30 may be configured to identify a wet hole due to the presence of multiple return signals.

The processor 30 may be configured to identify a wet hole due to the presence of multiple return signals, wherein the measured distance from the sensor to a first return signal is substantially the same as the distance from the first return signal to the second return signal.

The second return is considered to be caused by reflection of the water and not a reading of an actual geometry at that greater depth, and this second return may be used to indicate whether water is present.

The second return signal is understood to be a harmonic reflection and is present at multiples of the distance from the sensor.

The comparative distance of the first and second readings may be used to indicate a wet hole, where the second reading is at double the distance from the sensor to the first reading.

However, a return signal from a depth greater than the expected drilled depth may alternatively be indicative of a void at the bottom of the hole, exposed by the drilling, or may be a second return attributable to water in the hole.

To further verify the wet hole indication, the processor 30 may be configured to control the power output of the sensor based on the type of anomaly identified.

The processor 30 may be configured to vary power output of the sensor following detection of a wet hole, and to adjust feedback provided once new measurement data is provided following the power variation.

Following detection of a wet hole, for example where there appears to be a second return, the processor may be configured to reduce the power to see if the secondary return disappears at a particular level of power. This allows the differentiation between a real measurement (of geometry at a different depth) and a secondary reflective measurement that indicates presence of water.

An identification of a wet hole may further be supported by the signal readings being at the same depth across the hole, i.e. a very narrow spread of measurement data at that depth.

As shown in FIG. 6c, where the bottom of the hole is not wet, the return signal may be representative of the bottom of the hole, and comparable with the drilled depth, thus seeming to indicate an affirmative depth reading.

A signal intensity below the threshold is an indication of a lack of water, as the reading is characteristic of a reflection from soil and rock.

It is envisaged that a return signal representative of the bottom of a hole may have a signal intensity over a depth range that indicates rock and/or soil that is not flat, but spread over a particular range of depths that are evident when a hole is drilled, for example a range of depths having a variation of between 100 mm and 600 mm. For example, the depth measurement may be 30.1 to 30.6m, where the range of variation of depths is 500 mm.

The formation of a bottom of hole may be relatively even, and will therefore produce a relatively evenly distributed signal due to the relatively even surface.

Alternatively, the formation of a bottom of hole may be uneven, for example where the soil and rock is dry, or has collapsed to some extent.

Such a formation will produce a more scattered signal over a greater depth range, due to the uneven surface.

As shown in FIG. 6d, a return signal comprising two peaks may be produced where there is a partial bridge, or a void.

For example, a protrusion into the hole, or a bridge across the hole, may return a signal at that depth, which will be shallower than the expected hole depth. However, it may be that a second signal return is returned at the expected hole depth.

Comparison of these two returns may be sufficient to provide adequate confidence that the second strong return does indicate the bottom of the hole.

Such a result can be differentiated from the two peaks that indicate a wet hole, as shown in FIG. 6b, as both peaks are below the threshold, and the second peak is coincident with the expected hole depth.

The power adjustment may be used to further differentiate the two scenarios, as the return signal at the bottom of the hole would remain at the reduced power.

An example of another type of result, although not shown, might be a return at a shallower depth than the expected hole depth provided in the external data, with no second return signal, this may indicate a large protrusion into the hole, or possibly a collapsed hole.

In addition, a range of relatively weak return signals spread along an extended depth of the hole may similarly indicate a protrusion or bridge, with material being gradually distributed down the hole.

Processing of the return signal measurement data, using the strength and intensity of the signal, the spread of the signal across a depth range, and comparison with the drilled depth, for example provided by external data in the form of data from the drilling rig, may allow the system 10 to determine further characteristics around the form and moisture level at the bottom of the hole.

In use, as shown in FIG. 6, the sensor 20 of the measurement system 10 may be aimed down the hole and activated, the measurement data received may be analysed using the processor 30, and optionally compared with external drilling data, and the result provided to the operator.

Where the measurement data comprises a return signal of intensity indicative of soil and rock at depth readings with no additional returns, and the optional comparison with the drilling data identifies that the difference is within acceptable limits, the feedback of an affirmative depth measurement may be provided to the operator.

An example of an acceptable limit may be 2 m or less, for example 0.5 m, or alternatively may be expressed as a percentage of depth of the hole.

Where the difference between the measurement data and the external data is greater than the acceptable limit, the feedback of an anomaly may be provided to the operator.

In the event that anomalies are detected, it may be sufficient to refer the operator to deploy secondary measures, for example using other methods, to investigate the nature of the anomalies.

This method allows a simple measurement to be taken rapidly across a large number of holes, thus saving significant time over conventional methods.

However, it may be that anomalous data is able to be categorised, to determine the need for secondary measures, or the type of secondary measures, if required. Doing so may add further benefits to the measurement system 10.

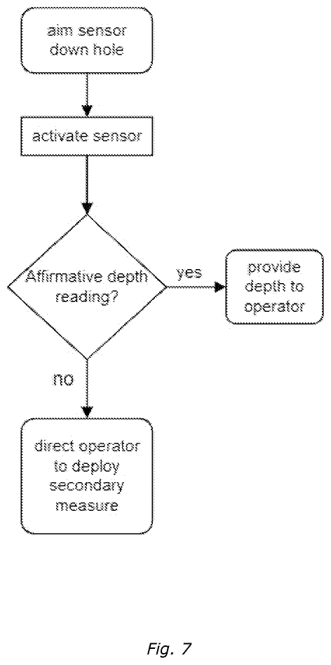

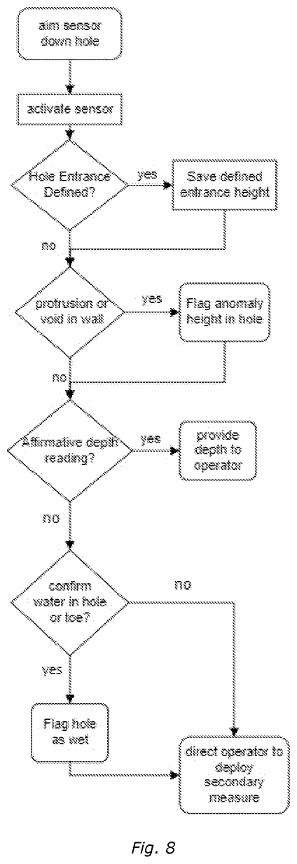

Referring now to FIG. 7, in which is shown another embodiment of a method of using the measurement system 10. Once the sensor 20 is activated the entrance is identified. To determine the depth of the hole, the top of the hole must be known. It may be that the measurement system 10 is mounted to a vehicle, for example a truck, so that it is retained at a particular height. Where the ground is relatively even such arrangement is simple as the measured depth across all the holes is known, being a distance from the measurement system 10 to the hole entrance, as mounted to the vehicle.

In such an embodiment, the hole entrance height may be defined initially using the height at which the measurement system 10 is mounted to the vehicle, and the defined height is recorded for all the holes recorded.

However, where a hole opening is geometrically complex, or is not on relatively even ground, the entrance height may not be well defined.

It may be necessary therefore to define an entrance height before the measurement is taken, an entrance height can be defined by using the sensor 20 to measure the hole entrance.

It is considered that any difference in height from the real level (RL) and the defined hole entrance would typically be not great enough to fall outside of acceptable limits, for example 0.5 m.

However, it may be that the entrance is particularly complex, for example sloped or uneven ground over a larger area around the opening, or at a height considerably different to the apparent RL, according to the operator.

In such cases an operator may define a hole entrance height by using measured data around the hole entrance, and may further offset this height to compensate for any perceived difference between the defined height and the surrounding geometry.

Alternatively, the system 10 may comprise a positional device 50, such as a GNSS receiver or RKT receiver, configured to determine either or both of the hole location and height.

In such embodiments, the processor 30 may be configured to define an entrance height using an arbitrary point provided by the positional device 50, and to confirm a depth from that point using measured data, then to optionally compare the depth with drilled data.

Once an entrance height is defined and a measurement taken, the measurement data can be interpreted from a baseline, being the defined entrance height.

It should be recognised that the identification of an entrance height is not specific to any one embodiment of the method.

In some embodiments, defining the entrance or collar of the hole may not be necessary. For example, where the designed floor level of the blast pattern is the consideration, the position of the toe of each hole relative to one another may be necessary, to ensure that the floor level after the blasting operation is sufficiently flat and even.

According to such embodiments, there is provided a hole measurement system comprising: a sensor configured to take measurements when directed down the hole to provide measurement data, a processor for analysing the data and providing feedback to an operator, wherein the feedback includes altitude of toe of the hole.

To ensure that the toes of the holes of the blast pattern will result in a sufficiently flat and even post-blast floor, the feedback includes altitude of the toe of the hole with respect to a datum which, for example, may be any of; sea level, toe of other holes or a design altitude.

The processor may be further configured to compare the altitude of the toe of the hole to a design altitude. This may or may not be in addition to a comparison with the collar or entrance heigh of the hole.

The altitude of the toe of each hole is advantageous, irrespective of the distance between the collar and the toe of the hole. For example, irregularities in the surface surrounding the collar may inhibit of prevent accurate readings of the collar height, and the lack of this information, which may otherwise present a problem requiring further measurement or assessment, may be obviated by determining that the post-blast floor level meetings design intent.

Furthermore, the measurement system 10 may be moved around the opening of the hole, to retrieve a number of different readings from different positions, which may be advantageous in increasing confidence in the readings.

For example, a reading of the bottom of the hole, in cases where there is a partial bridge, may be able to be taken only at certain positions, and the position, both laterally and vertically, and the angle of the system 10 may be altered to take the readings. This may in turn provide more data about the size of the protrusion/bridge, and the confidence of the bottom of hole reading.

The feedback of the processor 30 may provide the measurement data for an operator to interpret, or alternatively the processor 30 may analyse the measurement data against set parameters and control logic to make an assessment of the confidence of the reading, and either provide an operator with an affirmative depth measurement or direct the operator to take further measures.

Where the anomalous data is not able to provide an affirmative depth measurement, it may be that there is water in the hole or the toe of the hole (wet hole), or it may be that the geometry of the hole is such that there is insufficient area of surface perpendicular to the hole to return a sufficiently strong reading to be considered an affirmative depth measurement.

A wet hole may be indicated by the secondary reading, where a shallower reading may be received from water level, and a second reading at a greater depth is a reflection.

Using the processor 30 to adjust the power of the sensor 20 may cause the second reading to disappear if it is a reflection, whereas a reading of a real surface would be expected to remain.

Consequently, if secondary readings are detected, the power may be adjusted and the received data monitored to identify the hole as being wet.

The power adjustment may be undertaken rapidly and may be an automatic feature of the processor control logic, so that wet holes are able to be identified rapidly, in summarily the same amount of time as for affirmative depth measurement.

If a wet hole is identified, the hole may be flagged as wet, so that appropriate secondary measures can be deployed.

If the power adjustment does not result in identification of a wet hole, and the received data cannot be interpreted to a degree of confidence required to provide an affirmative depth measurement, the operator may be directed to deploy appropriate secondary measures.

The secondary measures deployed for a wet hole may be different to those deployed for other types of anomaly, and there is advantage in being able to distinguish a wet hole from another anomalous hole.

For example, a wet hole with a known water level may be blocked at a selected height above the water level and/or an explosive type suitable for water filled holes may be used.

The processing of the measurement data may require, or at least benefit from, clean readings with a high SNR.

The application, being measurement of holes, and in particular holes drilled in soil/rock with a limited number of types of anomalies, lends itself to this process.

The attenuation properties of rock and soil, and the geometry of holes, being long and narrow cylinders, produces low amounts of signal scatter and noise, thus enabling the measurement data to be betters processed and analysed.

Similar applications in other environments, for example in larger cavities such as caves or larger holes, or through different materials having different attenuation properties, may not allow the system 10 to function in the manner required.

The skilled reader would readily appreciate the nature of the materials appropriate for making the components of the embodiments of the arrangements described herein. Modifications and variations as would be apparent to the skilled addressee are intended to be covered by the accompanying claims.

1-23. (canceled)

24. A hole measurement system comprising:
a sensor configured to take measurements when directed down a hole to provide measurement data, the sensor comprising:
a radio frequency transmitter; and
a receiver, and
a processor for analyzing the measurement data and providing feedback to an operator, wherein the feedback indicates whether the measurement data represents a bottom of the hole, or an anomaly.

25. The hole measurement system according to claim 24, wherein the hole is a drilled blast hole.

26. The hole measurement system according to claim 24, wherein the hole is substantially full of air.

27. The hole measurement system according to claim 24, wherein the hole measurement system is configured to measure a plurality of holes in sequence.

28. The hole measurement system according to claim 24, wherein the hole measurement system is configured to take down hole measurements of holes comprised within a blast pattern.

29. The hole measurement system according to claim 24, wherein the hole measurement system is configured to record hole measurements of holes comprised within a blast pattern.

30. The hole measurement system according to claim 24, wherein the sensor comprises radar.

31. The hole measurement system according to claim 24, wherein the processor is further configured to:
receive external data, and compare the external data with the measurement data.

32. The hole measurement system according to claim 24, wherein the processor is further configured to:
analyze an anomaly measurement, and
determine the type of an anomaly associated with the anomaly measurement.

33. The hole measurement system according to claim 24, wherein the processor is configured to alter parameters of the sensor based on the measurement data.

34. The hole measurement system according to claim 24, wherein the processor is configured to take further measurements following analysis of the measured data, wherein the further measurements are taken using different sensor parameters than parameters used to obtain the measurements, and wherein the different sensor parameters are defined by the analysis of the measurement data.

35. The hole measurement system according to claim 24, wherein the processor is configured to:
vary power output of the sensor following detection of a wet hole, and
adjust feedback provided once new measurement data is provided following the power variation.

36. A hole measurement system comprising:
a sensor configured to take measurements when directed down a blast hole to provide measurement data, and
a processor for analyzing the measurement data and providing feedback to an operator, wherein the feedback indicates whether the measurement data represents a bottom of the blast hole, or an anomaly.

37. A hole measurement system comprising:
a sensor configured to take measurements from a position at or above an entrance of a hole when directed down the hole to provide measurement data, wherein the hole is a drilled blast hole; and
a processor for analyzing the measurement data and providing feedback to an operator, wherein the feedback indicates whether the measurement data represents a bottom of the drilled blast hole, or an anomaly.

38. A hole measurement system comprising:
a transmission means configured to direct a radio frequency signal down a hole,
a sensing means configured to receive radio frequency signals reflected from down the hole to provide measurement data, and
a processing means for analyzing the measurement data and providing feedback to an operator, wherein the feedback includes depth of the hole and identification of any anomalies.

39. A hole measurement system comprising:
a sensor configured to take measurements when directed down a hole to provide measurement data, and
a processor for analyzing the measurement data and providing feedback to an operator, wherein the feedback includes altitude of a toe of the hole with respect to a datum, wherein the datum is any one of: sea level, a toe of another hole in the same blast pattern, or a design altitude.

40. A method comprising:
aiming a sensor down a drilled blast hole;
transmitting a signal with the sensor;
receiving measurement data with the sensor;
analyzing the measurement data with a processor; and
providing feedback to an operator with the processor, wherein the feedback indicates whether the measurement data represents a bottom of the hole, or an anomaly.

41. A method comprising:
aiming a sensor down a hole;
transmitting a signal with the sensor;
receiving measurement data with the sensor;
analyzing the measurement data with a processor; and
providing feedback to an operator with the processor, providing feedback to the operator comprising:
in the event that an affirmative depth measurement is determined, providing feedback of the affirmative depth measurement; or,
in the event that anomalies are recorded, providing feedback that secondary measurements are required.

42. A method comprising:
aiming a radio frequency transmitting means down a hole,
using a radio frequency receiving means to receive signals from down the hole to provide measurement data,
using a processing means to analyze the measurement data to determine whether a depth of the hole is in accordance with a target depth.

43. The method according to claim 42, wherein the target depth is the drilled depth of the hole, wherein the data is provided by a drilling apparatus.
